(19) United States
(12) Patent Application Publication
(10) Pub. No.: US 2004/0116316 A1
(43) Pub. Date: Jun. 17, 2004

(54) Granulation process

(76) Inventors: Bertrand Michel, Nivelles (BE); Pierre Descamps, Rixensart (BE); Guzman Nachon, Reus (ES); Serge Firmin Alain Creutz, Rocourt (BE); Sophie Stassen, Rhode Saint Genese (BE)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/475,761

(22) PCT Filed: Apr. 25, 2002
(86) PCT No.: PCT/EP02/07640

(30) Foreign Application Priority Data
May 3, 2001 (GB) 0110863.8

(51) Int. Cl. C11D 17/00

(52) U.S. Cl. 510/444

(57) ABSTRACT

In an agglomeration process for the preparation of granules encapsulating a hydrophobic active material, the active material and a molten binder which has a melting point above ambient temperature are sprayed onto water soluble carrier particles while agitating the particles. A liquid which interacts exothermically with the carrier particles is sprayed onto the carrier particles separately from and just before or simultaneously with the active material and binder, so that the heat generated by the interaction reduces the cooling rate of the binder during the agglomeration process. For example the liquid can be water when the carrier particles have a positive heat of hydration and/or solution by water.

This invention relates to an agglomeration process for the preparation of granules encapsulating a hydrophobic active material and to the agglomerated granules thus produced.

Granules that can be prepared according to the invention include granulated foam control agents for laundry detergent powders. Laundry detergent powders usually require a foam-controlling agent in order to prevent overfoaming in washing machines. The antifoam ingredient, such as silicone compound can be conveniently added in the form of an encapsulated antifoam granule having a mean particle size and a bulk density close to the other solid ingredients of the detergent matrix for optimum mixing operation and to avoid further segregation of the antifoam granules. Other active ingredients such as fragrances can also be encapsulated and granulated for inclusion in a detergent powder.

### BACKGROUND OF THE INVENTION

U.S. Pat. No. 4,806,266 describes a method of making a particulate foam control agent by contacting 1 part by weight of silicone antifoam and not less than 1 part of an organic material, having a melting point in the range 45 to 80° C. and being insoluble in water, together in their liquid phase and causing them to form a solid in admixture. The silicone antifoam and the organic material are mixed together and are sprayed in the form of liquid droplets onto a fluidized bed of carrier particles, onto which the liquid droplets solidify. Encapsulated antifoam granules are further described for example in U.S. Pat. No. 5,767,053, EP-A-723795 and EP-A-831145.

WO-A-99/29816 describes mixing and granulating a hydrophobic liquid foam control agent and an anhydrous sodium carbonate carrier, characterised in that 1-10 wt% water is added to the granulator after the carrier and the foam control agent have been granulated together. WO99/29816 emphasises that the point of entry of the water should be so late that it enters the mixer after granulation of the carrier and antifoam is substantially complete.

WO-A-98/09701 mixes a water soluble carrier salt with up to 5% cellulose ether in a granulator and continues granulation while adding 1-10% aqueous polymeric polycarboxylate solution, then molten defoamer (paraffin wax plus stearyl bisamide) then 7-15% more polycarboxylate solution. WO-A-92/20770 describes mixing and granulating a sodium sulphate/sodium carbonate mixture with cellulose ether and water, followed by a liquid organopolysiloxane. WO-A-99/67354, WO-A-00/11126 and WO-A-00/11127 each describe spraying an aqueous antifoam emulsion onto carrier particles.

U.S. Pat. No. 5,505,875 describes a process for melt coating a material that is solid at room temperature onto sodium percarbonate particles by centrifigally atomising a finely divided solid in a continuously generated fog zone of the coating material in molten form. The coating material is a defoamer mixture which is based on wax and free from siloxane polymer.

Other granules encapsulating a hydrophobic active material include additives for building materials such as cement. EP 0811584 describes a granulated hydrophobing additive for use in cementitious compositions. The granulated additive comprises an active organopolysiloxane component, a water-soluble or water dispersible binder and carrier particles which may be water-soluble or water-insoluble.

JP-A-64-000187 describes an exothermic composition for heating food and beverages comprising calcium oxide and/or powder of natural calcium carbonate and anhydrous magnesium chloride.

### THE INVENTION

An agglomeration process according to the invention for the preparation of granules encapsulating a hydrophobic active material, in which the active material and a molten binder which has a melting point above ambient temperature are sprayed onto water soluble carrier particles while agitating the particles, is characterised in that a liquid which interacts exothermically with the carrier particles is sprayed onto the carrier particles separately from and just before or simultaneously with the active material and binder, so that the heat generated by hydration and/or solution reduces the cooling rate of the binder during the agglomeration process. Preferably the said liquid is water, alone or as an aqueous solution, and the carrier particles have a positive heat of hydration and/or solution by water.

Where the granules are foam control agent granules, the hydrophobic active material is preferably a silicone antifoam. The silicone antifoam generally comprises a polyorganosiloxane fluid and preferably also a hydrophobic particulate filler. The polysiloxane fluid may be a substantially linear polydiorganosiloxane or may be branched as described for example in EP-A-217501, U.S. Pat. No. 5,674,938 and U.S. Pat. No. 6,150,488. The organic groups in the polyorganosiloxane fluid generally comprise methyl groups and may additionally comprise a silicon-bonded substituent of the formula X-Ph, wherein X denotes a divalent aliphatic organic group bonded to silicon through a carbon atom and Ph denotes an aromatic group, as described in EP-A-1075864, or a higher alkyl group as described in EP-A-578423. A preferred hydrophobic filler is silica which is made hydrophobic by treatment with a methyl substituted organo-silicon material such as polydimethylsiloxane, hexamethyldisilazane, hexamethyldisiloxane or an organosilicon resin comprising monovalent groups (CH₃)₃SiO_{1/2}, or with a fatty acid, preferably at a temperature of at least 80° C.; alternatives are titania, ground quartz, alumina, aluminosilicates, an organic waxes, e.g. polyethylene wax or microcrystalline wax, and/or alkyl amides such as ethylenebisstearamide or methylenebisstearamide. The silicone antifoam preferably also contains a silicone resin, for example a MQ resin comprising groups of the formula R″₃SiO_{1/2} and SiO_{4/2} groups, wherein R″ denotes a monovalent hydrocarbon group. The silicone resin can be soluble, partially soluble or insoluble in the polysiloxane fluid.

The foam control agent can alternatively be based on a hydrophobic organic fluid, for example a mineral oil based antifoam as described in U.S. Pat. No. 5,693,256 or a mixture of paraffin wax and a bisamide as described in WO-A-98/09701. Such a fluid preferably contains a hydrophobic filler, for example of the type described above, and optionally a silicone resin such as an MQ resin.

An alternative hydrophobic material is a fragrance, which can be mixed with a molten binder which is a hydrophobic material that protects the fragrance from chemical degradation by detergent materials during storage. The binder can be a wax and is most preferably a waxy silicone polymer, for example a polydimethylsiloxane in which at least 20% of the silicon atoms of the silicone polymer have an alkyl substituent of at least 16 carbon atoms, for example 16-100 carbon atoms.

The hydrophobic active material can alternatively be a hydrophobing additive for cement, for example an organopolysiloxane as described in EP-A-511584, preferably a linear polydiorganosiloxane containing no more than 10% tri- or tetra-functional branching units, most preferably a linear polydimethylsiloxane, and/or a salt or ester of a long chain fatty acid such as palmitic, stearic or oleic acid. A further alternative is a hydrophobing additive for gypsum, which can be an organopolysiloxane as described above but is preferably an organopolysiloxane containing Si-bonded hydrogen, for example a trialkylsiloxy terminated methylhydrogenpolysiloxane in which at least 10%, preferably 10-50%, of the Si-bonded substituents are hydrogen.

The binder which is mixed with the hydrophobic active material has a melting point above ambient temperature but is capable of being molten at the operating temperature used for agglomeration. The binder thus generally has a melting point in the range 25 to 1001° C., preferably at least 40 or 45° C. up to 80° C. The binder is preferably soluble in water to some extent. Examples of binders are polyoxyalkylene polymers such as polyethylene glycol (PEG) with an average molecular weight of from 600 to 10000, reaction products of C₁₀-C₂₀ alcohols and ethylene oxide, more preferably C₁₅-C₂₀ primary alcohols such as tallow alcohol and 5-100, preferably 20-100 moles of ethylene oxide per mole of alcohol, polypropylene glycol, fatty acids or fatty alcohols having 12 to 20 carbon atoms, a monoester or diester of glycerol and such a fatty acid, for example a glycerol monostearate or distearate or a mixture of a water insoluble wax having a melting point in the range from above 55° C. to below 100° C. and a water-insoluble emulsifying agent. For a foam control agent, the binder should preferably be capable of dissolving in the wash liquor or at least be dispersible in the wash liquor.

The hydrophobic active material is preferably mixed with already molten binder. Alternatively the active material and binder can be mixed at ambient temperature followed by heating to melt the binder. The weight ratio of hydrophobic active material to binder is generally in the range 3:1 to 1:100, more preferably between 1:1 and 1:4. The mixture produced is preferably in the form of an emulsion of the hydrophobic active material in the molten binder. A surfactant may be used to aid dispersion of the silicone in the binder; the surfactant can be selected from anionic, cationic, nonionic and anphoteric surfactants. The surfactant can be added to the silicone undiluted or in emulsion before the silicone is mixed with the binder, or the surfactant and silicone can successively be added to the binder.

The carrier is a particulate material which interacts exothermically with the liquid which is sprayed during agglomeration. Preferably the carrier is soluble in water and has a positive heat of hydration and/or solution by water. Sodium carbonate, particularly anhydrous sodium carbonate, commonly known as light soda ash for the technical grade, is a preferred carrier for foam control agents; an alternative is sodium tripolyphosphate. Calcium oxide (lime or quicklime) is a preferred carrier for hydrophobing additives for cement and other construction materials. The mean particle radius of the carrier is preferably at least 10 microns and most preferably at least 25 microns up to 250 microns, more preferably up to 100 microns. The weight ratio of carrier particles to liquid ingredients (hydrophobic active material plus binder) is preferably in the range 1:1 to 50:1.

In the agglomeration process, the active material and the molten binder are sprayed onto the carrier particles while agitating the particles. The active material and the binder are preferably mixed before being sprayed. The initial temperature of the particles is generally ambient temperature, for example 10-30° C. although the particles can be pre-heated if desired. The temperature of the mixture of active material and molten binder is generally in the range 40-100° C. and preferably between 50 and 85° C. The particles are preferably agitated in a high shear mixer through which the particles pass continuously. In one preferred process, the particles are agitated in a vertical, continuous high shear mixer in which an emulsion of the active material in the molten binder is sprayed onto the particles. One example of such a mixer is a Flexomix mixer supplied by Hosokawa Schugi.

The invention will now be described with reference to the single FIGURE of the accompanying drawings, which is a diagrammatic cross-section of such a vertical, continuous high shear mixer.

The mixer comprises a vertical shaft (1) fitted with blades (2) rotating within a tubular housing (3). Particles are fed to the mixer through powder inlet (4). Below the powder inlet (4) but above the blades (2), the shaft (1) is surrounded by spraying nozzles (5,6). Most of the nozzles (5) are arranged to spray a mixture of hydrophobic active material and molten binder. At least one nozzle (6) is arranged to spray water, which may be an aqueous solution, or an alternative liquid which interacts exothermically with the carrier.

The particles fed through inlet (4) follow a helical path at the inner periphery of the mixing chamber (3), owing to the combination of gravity and centrifugal accelerations. The mixture of hydrophobic active material and molten binder sprayed through nozzle (5) and the water sprayed through nozzle (6) impinge on the particles as they follow this path. The blades (2) intimately mix the solid and liquid phases, and agglomeration occurs when the binder is cooled down below its melting point. The resulting agglomerated granules leave the mixer through outlet (7).

As an alternative to the vertical, continuous high shear mixer described above, horizontal high shear mixers may be used, in which an annular layer of the powder—liquid mixture is formed in the mixing chamber, with a residence time of a few seconds up to about 2 minutes. Examples of this family of machines are pin mixers (e.g. TAG series supplied by LB, RM-type machines from Rubberg-Mischtechnik), paddle mixers (e.g. CB series supplied by Lodige, Corimix from Drais-Manheim, Conax machines from Ruberg Mischtechnik). Other possible mixers which can be used in the process of the invention are ploughshare mixers, as sold for example by Lodige GmbH, twin counter-rotating paddle mixers, known as Forberg-type mixers, intensive mixers including a high shear mixing arm within a rotating cylindrical vessel, such as “Typ R” machines sold by Eirich, Zig-Zag mixers from Patterson-Kelley, and HEC machines sold by Niro.

The liquid, e.g. water, which interacts exothermcally with the carrier is co-sprayed with the binder and active material onto the particles of carrier. Preferably water is sprayed from a separate outlet so as to contact the particles at about the same position, or just earlier, as they pass through the mixer. The water which is sprayed can be water alone or can be an aqueous solution containing for example a water soluble polymer such as a polycarboxylate, for example polyacrylic acid or a copolymer of maleic anhydride with ethylene, methyl vinyl ether and/or methacrylic acid, polyethylene glycol, an ethoxylated fatty acid, polyvinyl pyrrolidone, glucose or a dissolved salt such as sodium silicate. Advantageously the solute is a material which reacts exothermically with the carrier. For example, with an alkaline carrier such as soda ash or lime, the solute can be acidic, for example a polycarboxylate of pH below 7. The temperature of the water can be 0 to 1001° C. or the water can be wholly or partly in the form of steam, although for a carrier such as soda ash having a high heat of hydration water at ambient temperature (e.g. 20-30° C.) is preferred. The amount of water sprayed onto the particles is generally at least 5% and preferably at least 10% based on the weight of the particles and may be up to 20% or 25%. Due to its much lower viscosity, water leads to a significantly finer spray than the binding emulsion does. The positive heat of hydration and/or solution by water of the carrier particles, for example light soda ash, is released at the particle—liquid interface. The cooling rate of the binding emulsion coating the soda ash particles is thus decreased. The duration of the granulation process, which requires the binding emulsion to be in the liquid stated to occur, is thereby extended.

The residence time of the particles in the mixing chamber is generally at least 0.1 and preferably at least 0.5 seconds up to 10 or even 60 seconds, for example about 1 second. A low residence time and hence high throughput give great economic advantages, but if the residence time is less than 0.1 second this time may be shorter than the cooling time required for the binder to solidify. For higher residence times, and especially if the residence time is at least 0.5 second, the residence time/cooling time ratio is sufficiently high so that retardation of the cooling rate (via co-spraying of water as discussed above) can impact positively the agglomeration process.

The flow rate of the water sprayed can be linked with an on-line particle size distribution measurement device, so that the particle size of the granules produced is monitored continuously and the proportion of water sprayed onto the particles is controlled in response to the observed particle size of the granules. If required, another process parameter, possibly in combination with the water flow rate, can be arranged to have a short-time response to the monitored granule size. For example the speed of the granulator can be controlled in this way.

We have found that without spraying water just before or simultaneously with the mixture of active material and binder, one consequence of the low residence time is that the particle size distribution at the outlet can be rather large. Fines (undersized material) need to be recovered in a filter coupled with the fluidized bed cooler and/or in the classification unit, and then recycled. Oversized material needs to be collected on a sieve, crushed down and recycled in the fluidized bed. Fines and oversized material have an impact on the stability of the agglomerated granules produced as well as on the productivity of the process and its stability. In addition, a wider particle size distribution of the final granules usually results in poorer flow properties that may affect the ease of dosing and mixing with other powders, for example in a powder detergent composition.

When water is sprayed just before or simultaneously with the mixture of active material and binder, the duration of the granulation process is extended as described above. The mean particle size of the granules is increased, with a narrower particle size distribution, as a result of the higher effective agglomeration time. Water is thus used as a granulation aid. If the binder is at least partially soluble in water, the water can also dissolve a fraction of the binder, so that it can additionally contribute as an aqueous binder to agglomeration. The main benefits of co-spraying of water are a better control of the particle size distribution of the granules leaving the mixer, an improvement of the handling properties of the granules, stemming from an optimized particle size distribution and from a modification of the internal structure of the granules, and lower recycling rates of fines.

We have found that water sprayed from a separate outlet is much more effective in retarding cooling of the binder than water emulsified into the mixture of hydrophobic active material and binder. Similarly water sprayed onto the particles after the binder mixture is largely ineffective, since the binder covers the surface of the particles and prevents much contact between the water and the water soluble carrier material.

The invention is illustrated by the following Examples, in which parts and percentages are by weight.

### EXAMPLES 1 AND 2

A silicone antifoam compound (active hydrophobic material) comprising 80 parts polydiorganosiloxane, 5 parts silicone resin and 5 parts silica was emulsified in 10 parts molten polyethylene glycol of M.Wt. 8000 (melting point 55-60° C.) at 80° C. using glycerol monostearate and polyethylene glycol (M.Wt. 1000) stearate as surfactants. 10% of the emulsion held at 80° C. was sprayed from two 6 mm nozzles at an atomising air pressure of 2 bar onto 90% light soda ash powder with a mean particle size of 70 microns (measured by laser diffraction) in a Flexomix 160 (Trade Mark) vertical continuous high shear mixer. The soda ash passed through the mixer with a residence time of about 1 second; the mixer blade speed was 4000 rpm. City water at ambient temperature was sprayed onto the carrier simultaneously with the antifoam emulsion through a third 6 mm nozzle. The amount of water based on total solids was 13.6% (Example 1) and 15.5% (Example 2). A comparative example was carried out in which no water was sprayed.

The mean particle size of the granules produced was 380 microns (Example 1) and 440 microns (Example 2) compared to 240 microns in the comparative example. 83% of the granulate of Example 1 was within the desired granule size range of 210-1400 microns, compared to 68% for the comparative example. The bulk density of the granulate was 600 kg/m3 (Example 1) and 590 kg/m3 (Example 2) compared to 520 kg/m3 in the comparative example.

### EXAMPLES 3 AND 4

The process of Example 1 was repeated except that the polyethylene glycol used had M.Wt 4000 (melting point 50-58° C.). The amount of water sprayed was 9.8% (Example 3) and 13.3% (example 4). 82% of the granulate of Example 3, and 91% of the granulate of Example 4, was within the desired granule size range, compared to 73% for a comparative experiment in which no water was sprayed.

Examples 3 and 4 were repeated on a larger vertical continuous high shear mixer having 10 nozzles spraying the antifoam and binder emulsion and 5 nozzles spraying water. Very similar results were obtained for granule size. In a flow test, the flowability of the granules of Example 3 was 96 mUs and of Example 4 105 mL/s compared to a target value of 100 ml/s and a flow rate of 91 ml/s for the granules produced in the comparative experiment.

### EXAMPLES 5 AND 6

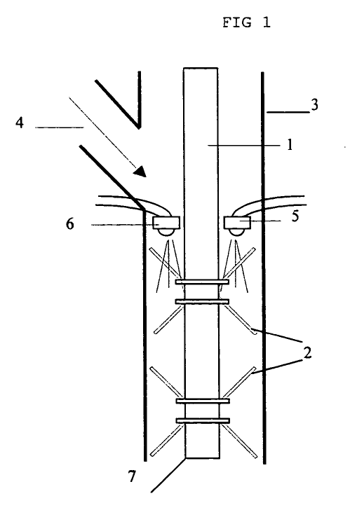

48.2% by weight of a silicone antifoam compound comprising 92% by weight polydiorganosiloxane, 4% silicone resin and 4% silica was emulsified in 51.8% glycerol monostearate binder which had been melted at 80° C. 100 kg/hour of the emulsion produced was fed to nozzle (5) of a vertical continuous high shear mixer of the type shown in FIG. 1. 250 kg/hour soda ash powder was fed through the mixer while 60 kg/hour (Example 5) or 80 kg/hour (Example 6) of a 30% aqueous solution of a polycarboxylate (acrylic acid polymer) was fed to nozzle (6). The polycarboxylate acts as an auxiliary binder as well as being a material which reacts exothermically with the soda ash carrier. In a comparative example C5, no aqueous solution was used. The mean particle size (mps) of the granules produced was analysed by sieve and by laser and the proportion of granules of particle size less than 212 μm was measured by sieve. The results are shown in Table 1 below

TABLE 1

| | mps sieve | mps laser | <212μm |
|---|---|---|---|
| Example | μm | μm | % by sieve |
| C5 | 358 | 449 | 39.7 |
| 5 | 463 | 591 | 15.1 |
| 6 | 486 | 541 | 16.9 |

What is claimed is:

1. An agglomeration process for the preparation of granules encapsulating a hydrophobic active material, in which the hydrophobic active material and a molten binder that has a melting point above ambient temperature, are sprayed onto water soluble carrier particles while agitating the carrier particles, wherein, a liquid which interacts exothermically with the carrier particles is sprayed onto the carrier particles separately from and just before or simultaneously with the hydrophobic active material and molten binder, so that the heat generated by exothermic interaction of the liquid and the carrier particles reduces the cooling rate of the binder during the agglomeration process.

2. A process as claimed in claim 1 wherein the liquid is water and the carrier particles have a positive heat of hydration.

3. A process as claimed in claim 1 wherein the liquid is water and the carrier particles have a positive heat generated by solution in water.

4. A process as claimed in claim 2, wherein the water that is sprayed comprises a solution of a material which reacts exothermically with the carrier particles.

5. A process as claimed in claim 2 wherein the carrier particles are sodium carbonate particles.

6. A process as claimed in claim 1 wherein the hydrophobic active material is a polysiloxane.

7. A process as claimed in claim 6 wherein the hydrophobic active material is a foam control agent and the process produces granules for addition to a detergent powder

8. A process as claimed in claim 2 wherein the granules are for addition to a cementitious construction material and the carrier is calcium oxide.

9. A process as claimed in claim 1 wherein the binder comprises polyethylene glycol.

10. A process as claimed in claim 1 wherein the binder is selected from the group consisting of: ethoxylated waxes, alcohol ethoxylates, monoesters of glycerol, diesters of glycerol and, a fatty acid having from 12 to 20 carbon atoms, and starch derivatives.

11. A process as claimed in claim 1 wherein the liquid is sprayed onto the carrier particles while the carrier particles are agitated in a high shear mixer through which the particles pass continuously.

12. A process as claimed in claim 11 wherein the residence time of the carrier particles in the mixer is between 0.1 second and 10 seconds.

13. A process as claimed in claim 11 wherein the mixer is a substantially vertical mixer through which the particles pass downwards.

14. A process as claimed in claim 2 wherein a mixture of the hydrophobic active material and binder is sprayed onto the carrier particles and the water is sprayed onto the carrier particles simultaneously with the mixture.

15. A process as claimed in claim 2 wherein 5-20% by weight of water is sprayed onto the carrier particles.

16. A process as claimed in claim 2 wherein the water is at least partially in the form of steam.

17. A process as claimed in claim 1 wherein the particle size of the granules produced is monitored continuously and the proportion of the said liquid sprayed onto the particles is controlled in response to the observed particle size of the granules.

18. Agglomerated granules produced by the process of claim 1.
